(19) United States
(12) Patent Application Publication
(10) Pub. No.: US 2006/0266598 A1
(43) Pub. Date: Nov. 30, 2006

(54) Control method for adjusting a disc brake

(76) Inventors: Johann Baumgartner, Moosburg (DE); Alf Siebke, Schondorf (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/492,157

(22) PCT Filed: Oct. 9, 2002
(86) PCT No.: PCT/EP02/11296

§ 371 Date: Nov. 3, 2004

(30) Foreign Application Priority Data
Oct. 10, 2001 (DE) 101500475

(51) Int. Cl. F16D 55/08

(52) U.S. Cl. 188/72.7

(57) ABSTRACT

A method for cotrolling a disk brake comprising a caliper which overlaps a brake disk, brake linings arranged on both sides of the brake disk, a tensing device for tensing the disk brake and an adjustment system which is driven by an electric motor and which can be controlled by means of a control device. The inventive method consists of the following steps: a) determination of the braking power occurring during braking; b) comparison of the determined braking power with a braking power threshold value; c) control of the adjustment system in order to carry out adjustment if the braking power threshold is exceeded.

The invention relates to a control method for controlling an adjusting system of a disc brake, having a caliper which reaches over a brake disc, brake pads arranged on both sides of the brake disc, an application device for applying the disc brake and the adjusting system, which can be controlled by way of a control device and is designed with an electric motor, for adjusting the brake pads in the event of the occurrence of a brake pad wear, the control method being implemented by means of a program of the control device.

Disc brakes having an adjusting system driven by an electric motor are known per se; thus, for example, from German Patent Document DE 197565 19 A1. In addition, a center arrangement of the adjusting device between the rotating or adjusting screws is also known; thus, from German Patent Document DE 37 16 202 A1 or International Patent Document WO 99/05428.

In International Patent Document 99/05428, a particularly simple control method is described which can be implemented without additional wear sensors. For this purpose, it is suggested that the release play adjustment be carried out after each braking or after a defined fixed number of brakings. For this purpose, it is indicated that, when a corresponding analyzing logic is present in the electric braking system, the brake pad wear can be monitored. It is stated that this could take place, for example, by means of a special wear sensor, which, however, would require high expenditures and may possibly also not be very exact.

It is therefore an object of the invention to provide a reliable control method for adjusting systems of disc brakes of the above-mentioned type, which permits the determination of the wear at the brake pads also without the use of special wear sensors and the relieving of the adjusting system by a reduction of the number of adjusting operations.

The invention achieves this task by means of the object of claim 1.

Accordingly, the control method is designed as a computer program of the control device and contains the following steps:
Determination of the braking power occurring during a braking,
comparison of the determined braking power with a braking power limit value, and
controlling the adjusting system for implementing an adjustment in the event of an exceeding of the braking power limit value.

The special advantage of the invention is the fact that an adjustment will in each case only take place when the check of the consumed braking power indicates that an adjustment should be necessary. The frequency of the adjusting operations is therefore reduced and the adjusting system is relieved. In addition, the determination of the braking power requires no special sensor to be provided specifically for this purpose and is therefore extremely well suited for indicating the wear.

Since a reduction of the frequency of the adjusting operations is permitted, the electric motor is relieved with respect to its power and wear, which provides the possibility of designing the electric motor in a relatively small size and in a cost-effective manner. Furthermore, the possibility is created of utilizing the adjusting system for additional tasks, which increases the efficiency of the electric adjusting system and thus of the entire disc brake.

Here, it is particularly advantageous for the amount of the braking power converted during a braking to be intermediately stored in a memory and to be added up over several brakings and then to be compared with the prestored braking power limit value.

According to a variant of the invention, the braking power is calculated without additional sensors directly from the braking torque and the rotational wheel angle.

The rotational wheel angle is preferably determined by means of an ABS system having a revolving field sensor which is always present in modern braking systems and therefore does not represent any additional equipment-related expenditures.

Likewise, the braking torque is preferably determined in a simple manner from the brake cylinder pressure, which is also fed to an EBS or ABS control computer or to a control device.

Expediently—this can be empirically determined—an adjustment is in each case initiated when a power limit value of from 2 to 8 MJ, particularly SMJ, is exceeded in order to, on the one hand, keep the frequency of the adjusting operations relatively low and in order to, on the other hand, always maintain a sufficient braking safety. The invention is suitable for disc brakes with an electric-motor-driven or pneumatic operation as well as with a floating, fixed or sliding caliper. On both sides of the brake disc, the adjusting system preferably comprises in each case at least one of the electric-motor-driven adjusting devices.

According to another, particularly advantageous variant of the invention, which can also be considered independently, the application point in time of the brake is determined as follows: After one or more brakings, the adjusting system is controlled in the sense of an adjusting until the at least one adjusting motor is stopped as a result of the friction occurring because of the application force.

In this case, the application point in time of the adjusting motor is expediently determined by monitoring the voltage and/or current characteristics of the adjusting motor.

The application point in time is preferably determined separately on both sides of the brake disc in that the moment is in each case determined by which the at least one adjusting moment on each side of the brake disc is stopped as a result of the friction occurring because of the application force.

This, when an unequally high brake pad wear is determined on both sides of the brake disc, makes it possible to unequally adjust the release play on both sides of the brake disc on the basis of a determination of unequal application points in time.

As a result of the determination of the application point in time of each brake by means a control method according to Claim 21 and a comparison of the application point in time of different brakes of the vehicle or of a vehicle combination—consisting of a tractor vehicle and a trailer vehicle—, according to another aspect of the invention, which can also be considered independently, the various brakes of the vehicle can be adjusted such that the application points in time of the various brakes are mutually adapted. When, for example, an unequal wear occurs because of a brake disc that has become sluggish, it is expedient to minimally adjust the release play on the exterior side of the brake disc. As a result of this measure, the outer brake pad is made fully effective also in the case of a sluggish brake disc, and, in this manner, a service interval of the brake can be bridged without special disturbances.

The invention also provides a simple method for determining the power converted during brakings, in which the braking power is computed from the braking torque and the rotational angle of the wheel covered during brakings.

Furthermore, the invention provides a particularly uncomplicated method of determining the brake pad wear of a disc brake of a vehicle by means of a method of determining the power used during brakings, by which the braking power is computed from the braking torque and the rotational angle of the wheel covered during brakings, and by which the amounts of the converted braking power added up since the start of the operation of the vehicle or since the last change of brake pads are detected and added up and/or indicated to a driver by means of an indicating device. By means of such a method, a simple device can be created for indicating the brake pad wear, which does not require a special wear sensor in the / at the brake pad.

Additional advantageous further developments of the invention are contained in the remaining subclaims.

In the following, preferred embodiments will be described in detail by means of the drawing.

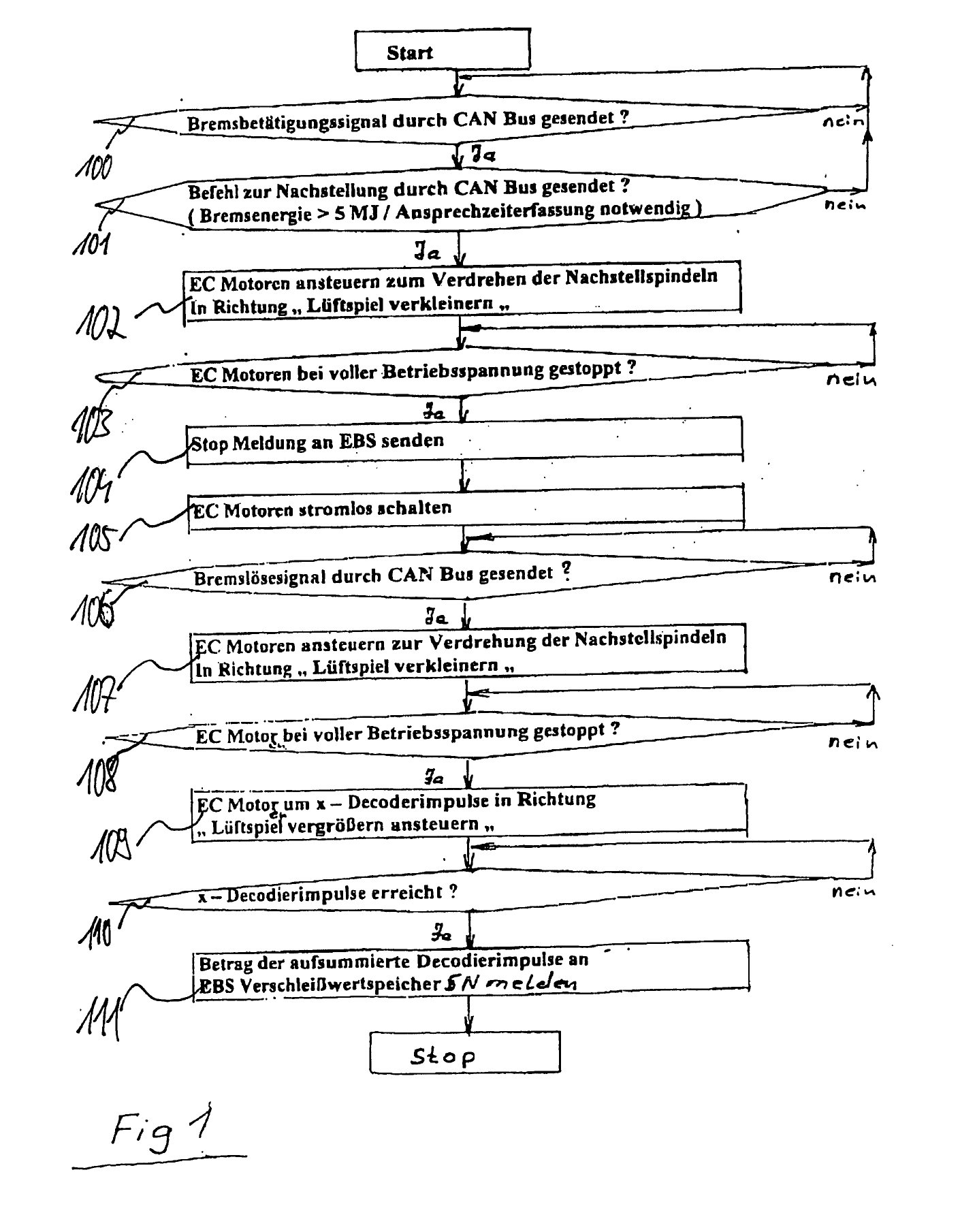

FIG. 1 is a view of a first embodiment of a control routine for the release play adjustment as well as for recognizing the response point in time and for detecting the wear condition;

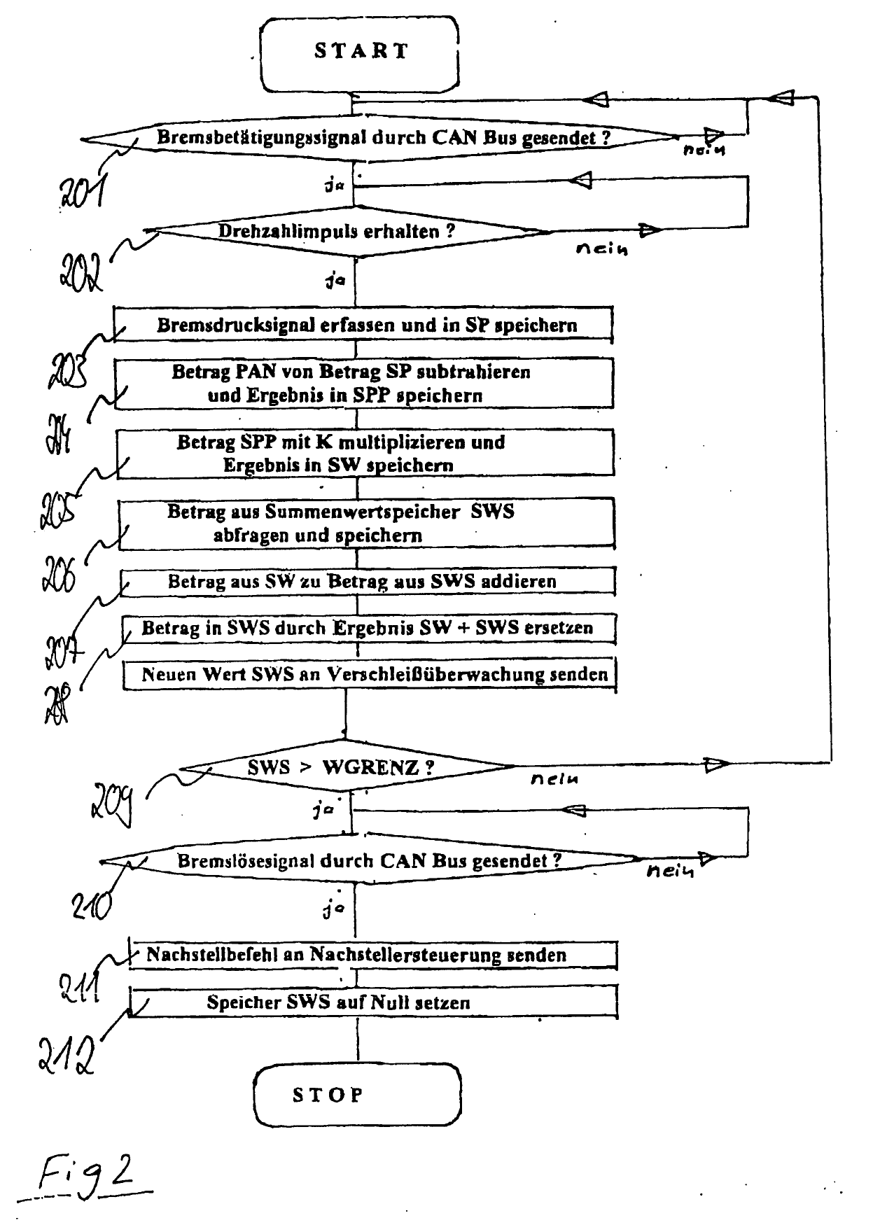

FIG. 2 is a view of a routine for determining the braking power converted during brakings;

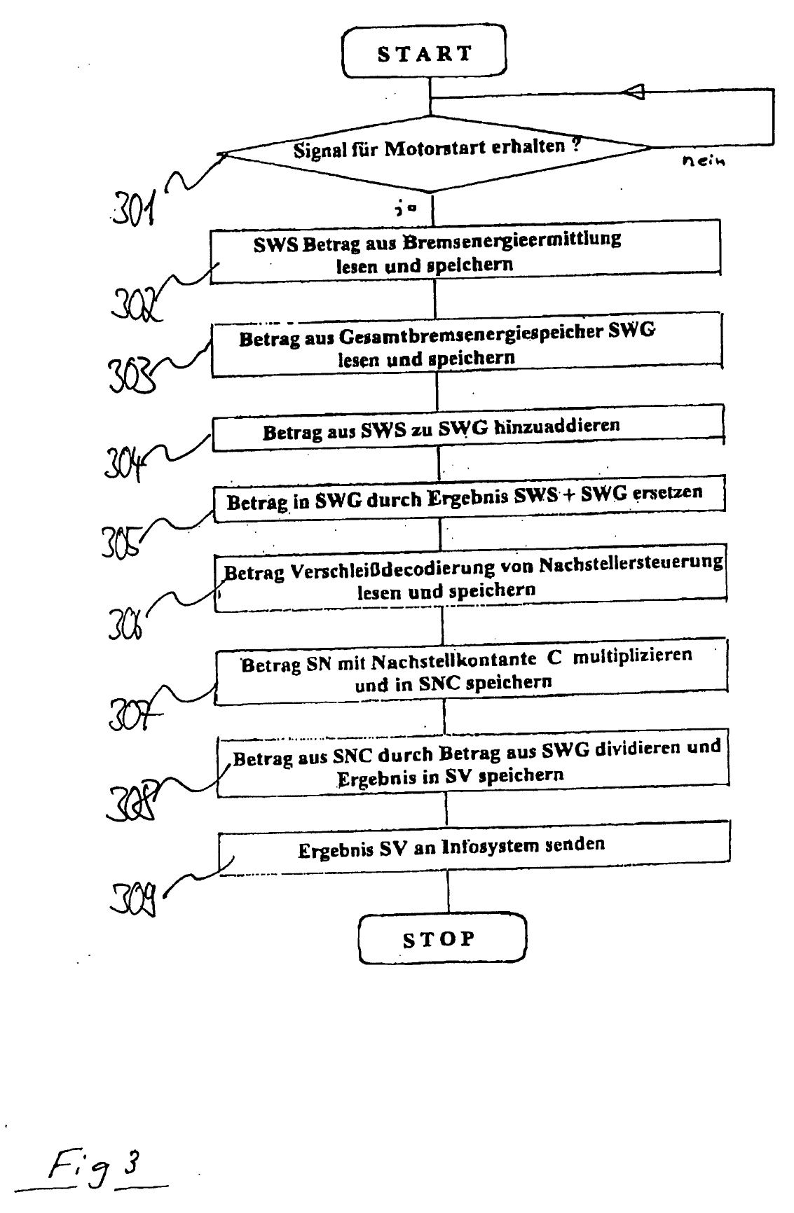

FIG. 3 is a view of a routine for determining the wear;

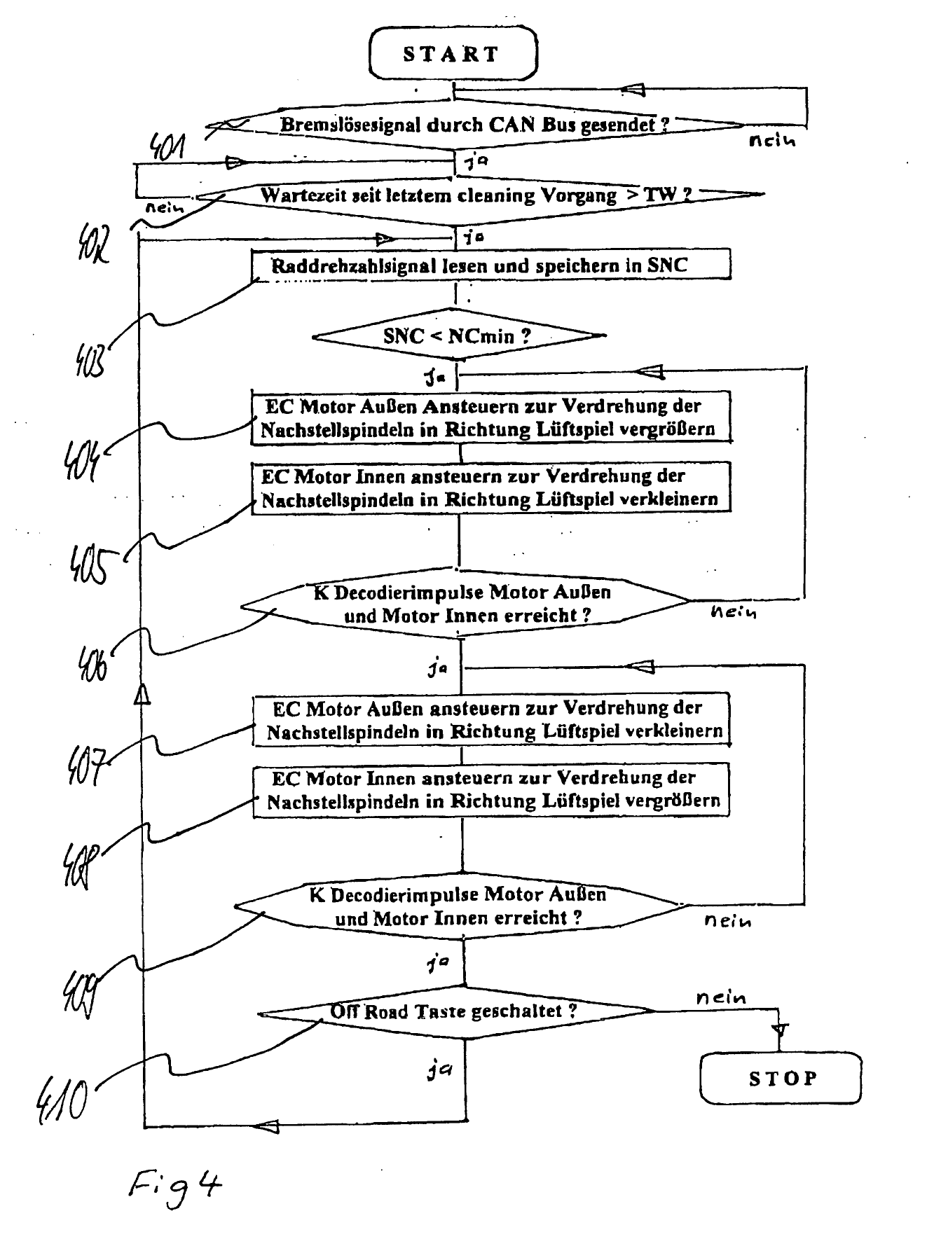

FIG. 4 is a view of a routine for controlling a cleaning function and securing the displaceability of the brake disc;

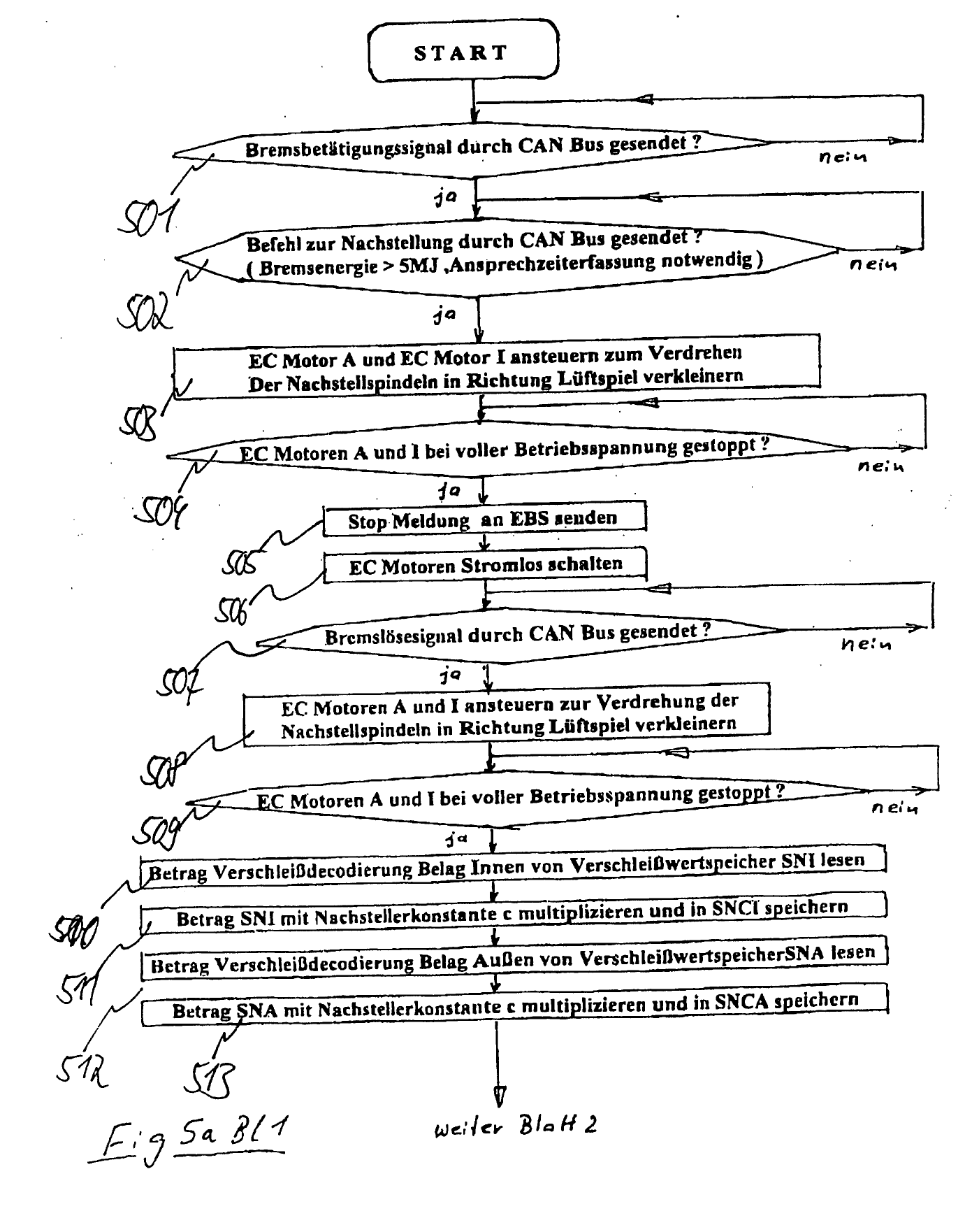

FIG. 5a is a view of a control routine for the individual release play adjustment for recognizing the response point in time as well as for detecting the wear condition;

FIG. 5b is a view of the continuation of the routine from FIG. 5a;

FIG. 6 is a view of a control routine for the active restoring of the brake disc;

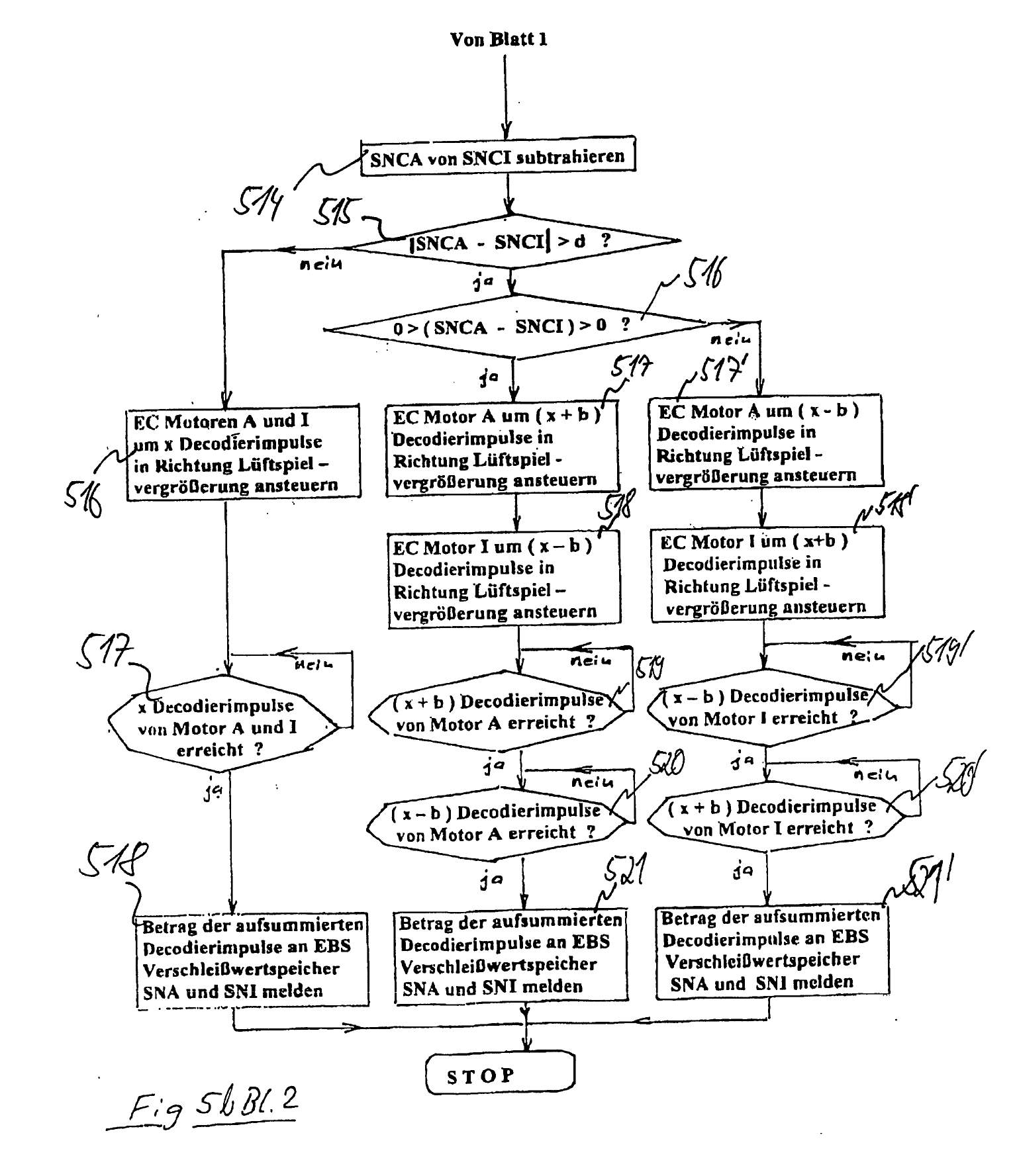

FIG. 7 is a schematic diagram of a disc brake;

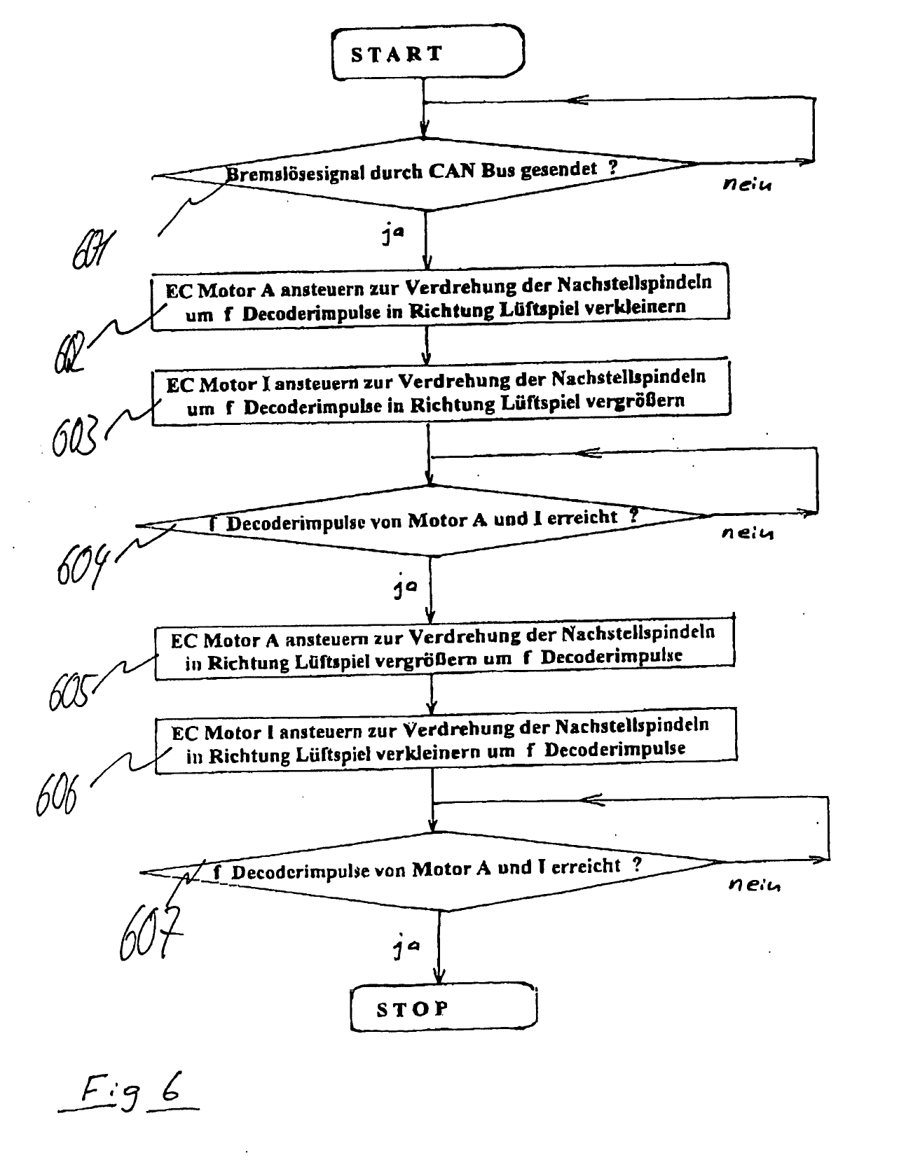

FIG. 8 is a partially cut top view of a disc brake.

FIG. 7 illustrates a pneumatically operable disc brake which has a caliper comprising a brake disc 3 in its upper circumferential area. However, an electric-motor-driven operation is also conceivable but not shown.

On both sides of the brake disc 3, brake pads 5, 7 are arranged which can be displaced in the direction of the brake disc and away from it—that is, perpendicularly to the plane of the brake disc 3—, which brake pads 5, 7, in the customary manner, consisting of a brake pad support 5a, 7a and a pad material 5b, 7b applied thereto.

In FIG. 7, in the right lower section 9, which extends in the direction of the—not shown—wheel axle, the caliper is fastened by means of at least one or preferably several bolts 11, for example, to an axle flange 13 of the disc brake.

Here, the brake disc 3 is constructed, for example, as a sliding disc which is displaceable relative to the caliper 1 on the wheel axle by the amount of the working stroke to be overcome during brakings. As an alternative or in addition, the caliper could also be constructed to be displaceable or swivellable. It would also be conceivable for the caliper and/or the brake disc 3 to be constructed to be elastically deformable in each case by a portion of the path of the working stroke.

Since, according to FIG. 1, a relative mobility exists between the caliper and brake disc, which essentially corresponds to the amount of the working stroke, an adjusting system is provided. It comprises adjusting devices 15, 17 on both sides of the brake disc for compensating the release play or the brake pad wear occurring during brakings.

Here, on each side of the brake disc, the adjusting devices 15, 17 consist, for example, of in each case at least one or more,preferably two adjusting sleeves 19, 21, in which bolt-type projections 24 of pressure pieces 23, 25 are rotatably arranged, so that a relative axial mobility exists between the adjusting sleeves 21, 23 as well as the pressure pieces 23, 25. Naturally, a reverse arrangement is also conceivable in which the pressure pieces have a—not shown—sleeve-type projection, which is rotatable on a bolt.

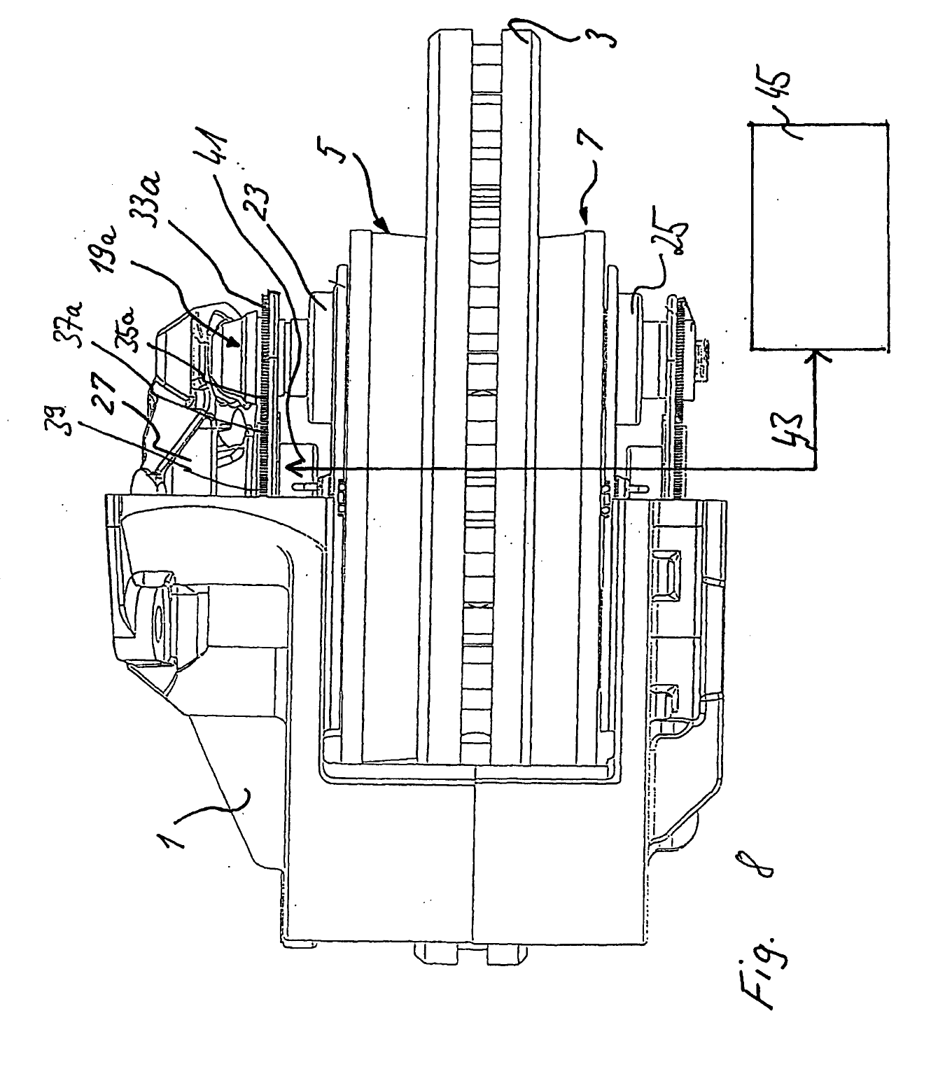

The adjusting device 15 illustrated on the right in FIG. 7 is supported on a rotary lever 27 which, in addition to the adjusting device 15, is part of the application device, which rotary lever 27 can be operated in its area, which is at the top in FIG. 13, by a piston rod 29 of a brake cylinder 31, and which, in its bottom part, is disposed, for example, by way of ball elements (not shown here) or another bearing at the caliper, on its side facing away from the caliper, the rotary lever 27 also being disposed on the adjusting sleeve 19 directly or by way of intermediate elements, such as balls and/or additional transition pieces.

The adjusting sleeve 21 arranged on the side of the brake disc 1 situated opposite the rotary lever 27, in contrast, is supported directly on the caliper interior.

In the case of the brake of FIG. 7, two of the adjusting sleeves 19, 21 (see also FIG. 15) as well as two of the pressure pieces 23, 25, which can be synchronized with one another by way of a gearwheel mechanism, are in each case arranged in both sides of the brake disc.

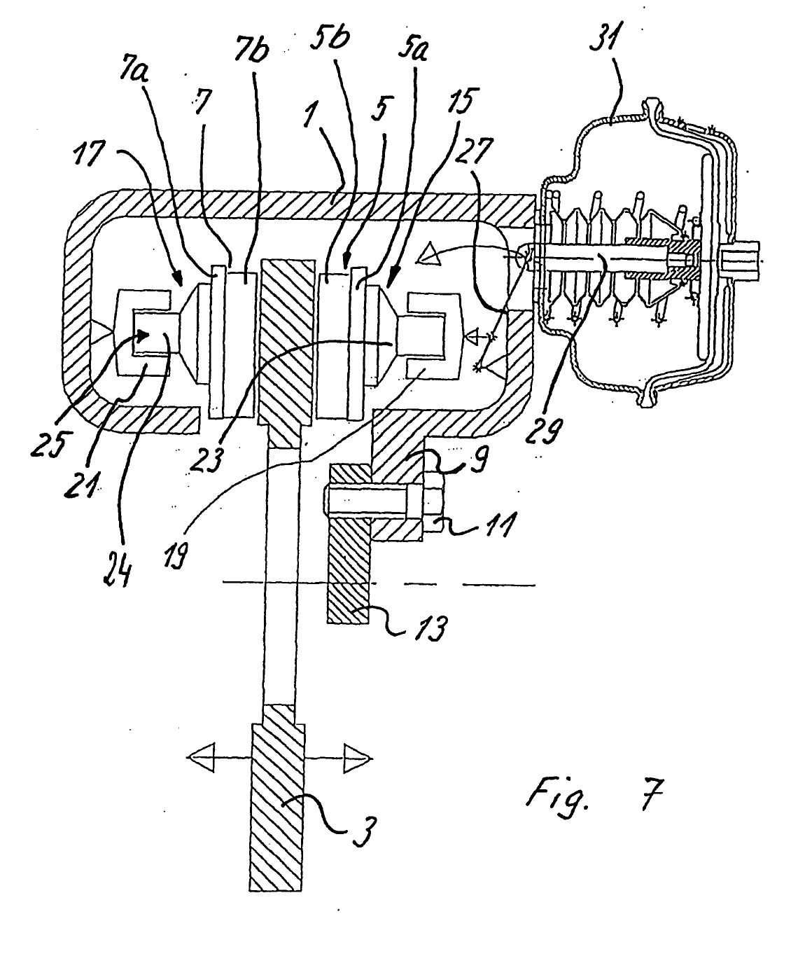

This is also particularly easily recognizable in FIG. 9. The adjusting sleeves 19a shown here are provided at their outer circumference with a gearwheel 33a or with a gearwheel-type projection which meshes with a gearwheel 35a which is, in turn, driven by a gearwheel 37a, which itself is rotated by an output gearwheel 39 of an electric motor 41. All gearwheels 33a, 35a, 37a, 39 are situated in a plane.

In addition, it is schematically indicated in FIG. 7 that the electric motor 41 is connected by way of a data and supply line 43 with a control device 45 (for example, an ABS and/or EBS control device) which, in turn, may be connected with the remaining vehicle electronic system and to which normally the ABS sensors are also connected.

FIG. 1 shows a control method for electric wear adjusting systems which is particularly suitable for brakes of the type of FIGS. 7 and 8, but not exclusively for this type.

In particular, the control method is not limited to brakes with an electric wear adjustment on both sides but, according to its basic idea, is in principle also suitable for brakes with a one-sided wear adjustment.

However, by means of the two-sided electric wear adjustment, particularly advantageous variants of the control are obtained which will be illustrated in the following detailed description.

FIG. 1 shows a particularly uncomplicated and simple control method for adjusting the release play.

After a defined number of brake operations—in special cases, even during each brake operation—, the adjusting system or each electric motor on both sides of the disc brake receives a control pulse from an electronic control system or the control device 43 connected on the input side. This control device 43 may be formed, for example, by an EBS system or by an electronic control system integrated directly into the brake, but also by any other electronic control system assigned to the disc brake or connected to the input side, if this electronic control system is designed with suitable connections to the disc brake as well as with a computing device or a microprocessor for processing the sensed signals and for the output of corresponding control signals to the disc brake.

This controlling of the braking system takes place only when the brake is controlled in the sense of an application. This can be sensed, for example, by means of the signal of a brake pressure switch or by means of another equivalent signal from the EBS system.

Because of the relatively low regulating speed of the electric motor, first only a slight advancement takes place because the adjusting motor is stopped because of the friction in the screw system occurring because of the application force.

This stopping function is advantageously utilized for individually determining the application point in time of each brake. This information permits an equalization of the application points of all brakes of a vehicle combination, which makes it possible to implement a brake coordination particularly between a towed vehicle and a towing vehicle in the case of vehicle combinations.

For this purpose, the adjusting operation preferably takes place during each braking operation until the brake control has been coordinated. After the termination of the braking operation —which is indicated, for example, by the extinction of the brake pressure signal—, the adjusting device is controlled again in the sense of a release play reduction until the motor is stopped during the placing/contact of the brake shoes on the brake disc as a result of the frictional force occurring in the adjusting screws.

From this position, a controlling now takes place in the release direction, in which case a defined number of motor revolutions is implemented which generates the desired release play.

In its essential features, a control method of this type is illustrated in FIG. 1. According to FIG. 1, the following control routine will be implemented in the microprocessor of the control device 45 for adjusting the release play as well as for recognizing the response point in time and for detecting the wear condition.

First, it is determined within the control routine by means of a program step 100 whether an operating signal was sent by a data transmission bus—for example, a CAN bus—.

If this is not so, the checking of the presence of the brake operating signal is started again.

As an alternative, the routine can naturally also rest until an input takes place or is present by means of the brake operating signal.

If a brake operating signal was sent by the data bus, it is determined whether a command for the adjustment was transmitted by the CAN bus.

This is preferably determined by means of a checking of the braking power consumed during preceding brakings, for which a response detection is required, which will be discussed in detail in the following by means of the additional figures.

If no command for an adjustment was sent by the CAN bus (Step 101), no adjustment will place and the program routine returns to the start because an adjustment is not yet necessary during this braking.

A special advantage of the adjusting routine according to the invention is illustrated here by the fact that an adjustment will in each case take place only when the checking of the consumed braking power reveals that an adjustment should be necessary. If it was determined in Step 101 that a command for an adjustment by the CAN bus is present, the electric motors (EC motors) are controlled for rotating the adjusting screws in order to reduce the release play (Step 102).

In this case, it is checked at what time the electric motors are stopped at full working voltage. If this is the case, the brake pad is placed against the brake disc so that no further adjusting movement is possible. Thus, the response point in time of the brake can therefore be precisely determined in an uncomplicated manner.

If it is determined in Step 103 that the EC motors were stopped at a full working voltage, a stop message is sent to the EBS control unit (Step 104), and the electric motors are switched to current-free in a next Step 105.

If a brake release signal was now sent by the CAN bus (Step 106), the electric motors are controlled in a further Step 107 for rotating the adjusting screws (rotating screws 19, 21) in the direction of a reduction of the release play.

After the overcoming of the release play, the electric motors rest on the brake disc. This means that the electric motor is stopped at a full working voltage. If this is determined in a further Step 108, the electric motor is controlled in the opposite direction in a further Step 109 (control by x decoding pulses in the “enlarge release play” direction) in order to adjust the release play in Step 109.

If it is determined that the defined number of x decoding pulses in the direction of an enlargement of the release play has been reached, the release play was adjusted correctly and the amount of the added-up decoding pulses is transmitted to an EBS wear value memory (Step 111).

After the correct adjustment of the release play, the routine of FIG. 1 returns into its starting position.

A special advantage of the system is the fact that an adjusting of the brake does not take place after each brake application but only after a defined number of brakings. For this purpose, it is necessary to design the control method such that the frequency of the release play adjustment can be determined in a simple manner.

Although in a very simple control, the release play adjustment can take place after each braking operation, this leads to a high stressing of the adjusting mechanism. In contrast, a release play adjustment should only take place when a change of the release play as a result of wear, thermal expansion or shrinkage of the friction bodies during or after hot braking takes place beyond a certain amount, or when required by other system functions, such as the coordination of the response point in time of the brakes of a vehicle or of a vehicle combination.

The tolerance amount of the occurred release play deviations from the desired value may, for example, be several percent (for example, 10 percent) of the desired release play. Expressed in numbers, this means, for example, that, in the case of a desired release play of 0.4 mm, the tolerance amount is 0.04 mm of the total release play, which, during braking with an electric adjusting device on both sides, corresponds to a release play of 0.02 mm for each side.

However, for the determination of the tolerance release play, it is not possible to simply determine the occurred brake wear over the distance covered by the vehicle or for the driving time since the last adjusting operation. Thus, there is naturally an important difference between an operation of a commercial vehicle, for example, in a flat terrain and an operation in a mountainous terrain. However, according to an idea of the invention, the braking power consumed during brakings represents a more suitable quantity. According to an idea of the invention, this quantity is determined approximately from the rotational speed signal and the brake pressure signal:
W_{B}=M_{B} _{_{—}}_{B},

wherein:

W_{B}: braking power;

M_{B}: braking torque;

_B: rotational wheel angle.

The rotational wheel angle is determined directly by means of the rotational speed sensor required, for example, for the ABS function of the brake control system. The rotational speed sensor consists of a revolving field, which revolves with the wheel hub, and of a stationary transducer which registers the passing-by teeth, the field coils etc. of the revolving field by means of a voltage pulse. In the case of, for example, 100 teeth per revolving field, one pulse therefore corresponds to a rotational wheel angle of 3.6°. By adding-up these pulses, the rotational wheel angle is determined during the braking phase.

The braking torque is determined as follows by means of the pressure sensor present in the EBS system by determining the brake cylinder pressure:
M_{B}=(P_{Z}−P_{An})A_{Z} iεC*r_{eff},

herein:

P_{Z}=pressure in the brake cylinder and

P_{An}=application pressure of the brake

i=power ratio of the brake

ε=mechanical efficiency of the power ratio mechanism of the brake

C*=brake coefficient=2μ_{B}

μ_{B}=coefficient of friction of the brake pad

r_{eff}=effective friction radius of the brake disc

Z=number of added-up rotational angle pulses

A_{Z}=effective piston surface of the brake cylinder.

With the exception of the brake cylinder pressure, all above-mentioned quantities can be assumed to be constant quantities. Although the coefficient of friction and thus the C* value of the brake are subject to operationally caused fluctuations, for the present purpose, an average value can reliably be used as a constant quantity for the computation.

This results in the following:
M_{B}=(P_{Z}−P_{An})A_{Z} iεC*r_{eff},
M_{B}=(P_{Z}−P_{An})K

For a revolving field with n—teeth, the rotational wheel angle per tooth amounts to
_{—}=2π/n.

As a result, the following is obtained for the braking power converted per tooth, that is, per rotational speed pulse:
W=(P_{Z}−P_{An})K;

wherein:
K=A_{Z} iεC*r_{eff} 2π/n.

The converted braking power is thereby determined by simple linkages of the brake cylinder pressure signal with the number of rotational speed pulses.

For the beginning of a subsequent adjusting operation, a limit value can now be defined which is determined by the adding-up of the values (P_{Z}−P_{An})×K of successive brakings. When this cumulative value reaches the defined limit value, an adjusting operation is initiated by the electronic control system of the adjusting system

The interrelationship between wear and braking power is experimentally determined for the used friction pairing.

For a typical brake pad of the disc brake type for commercial vehicles with 22.5-inch wheels, the analysis of different wear examinations reveals that a total wear of both brake pads of approximately 0.02 mm is reached at approximately 5 MJ (Mega Joule) of converted braking power.

In extreme braking conditions, for example, high-mountain driving, the limit power of 5 MI is already reached by a single braking operation. However, in the case of normal adaptation brakes, 5 to 50 braking operations are required for reaching the limit value.

By defining the limit value to 5 MJ of converted braking power (relative to disc brakes for commercial vehicles with 22,S-IaII wheels), the effect of the increase of the brake disc and the brake pad during extreme braking is sufficiently ensured because the defined braking power is reached under these conditions even in the case of a single braking operation.

During extreme brakings with approximately 5 MJ of braking power per operation, the brake disc temperature can be increased by 400 0, whereby an enlargement of the brake disc of approximately 0.2 mm occurs, while simultaneously the brake pads are worn by 0.02 mm. If, before the starting of the braking, the release play is therefore adjusted to approximately 0.3 to 0.4 mm, even in the event of such extreme brakings, no growth of the brake can occur with the result of a possible overheating.

FIG. 2 is a corresponding representation of the routine for determining the converted braking power as a flow chart.

After a start of the routine, it is determined whether a brake signal was sent by the CAN bus (Step 201); then, it is checked whether a rotational speed pulse was received (Step 202). If this is not so, it is further examined whether a rotational speed pulse is present. If a rotational speed pulse is present, the brake pressure signal is first detected and stored in a memory SP (Step 203); then the amount of the application pressure P_{An} is subtracted from the amount SP, and the result is stored in a field SPP (Step 204); whereupon the amount SPP is multiplied by K and is stored in a memory SW (Step 205).

Then the amount is queried from the cumulative value memory SWS and is stored (206), and the amount from the memory SW is added to the amount from the cumulative value memory SWS (Step 207); and then the amount in the cumulative value memory SWS is replaced by the result of the addition of the value SW and the value SWS (Step 208).

If this value in the cumulative value memory exceeds a defined limit value WLIMIT (Step 209), an adjusting command 211 is sent to the adjusting control (see FIG. 1) as soon as it is determined that a brake release signal is present (Step 210), and the cumulative value memory is set to zero in a Step 212.

If, in contrast, in Step 209, the value in the cumulative value memory is smaller than the defined limit value WLIMIT, the program returns to the start.

Thus, it can be achieved in an uncomplicated manner to utilize the above-indicated formula interrelationship for adjusting the braking system by a determination of the braking power consumed during brakings. The added-up braking power corresponds to the value SWS in the cumulative value memory. The result of the addition can also be used, for example, for judging the wear behavior of the brake pads and for indicating conspicuous deviations.

For this purpose, the amounts of the converted braking power added up since the start of the operation of the vehicle or since the last change of the brake pads are detected and stored. These values are compared with the defined values stored in the electronic analyzing system. In this manner, conditions which lead to an excessive brake wear can be recognized in time and can be stopped. Such conditions may be the result, for example, of defects at the wheel brakes or in the brake control, of a lack of an effect of the brakes of the other vehicle in a vehicle combination, or of a particularly braking-intensive driving method, etc.

FIG. 3 shows such a monitoring routine. In a first Step 301 of this program routine for monitoring wear or for determining any conspicuousness of the system, after the determination of a motor start or after receiving a signal for the motor start (Step 301), the amount is read out of the cumulative value memory SWS and is stored intermediately.

Further, the total braking power memory is read out and intermediately stored (Step 303). Here, this total braking power value is called SWG. Then, in a Step 304, the amounts from SWS and SWG are added together, and the amount in the total braking power memory SWG is replaced by the sum from SWS and SWG (Step 305); whereupon the amount of the wear decoding control of the adjuster control is read out and stored (Step 306). Then the amount SN is multiplied by an adjusting constant C and is stored in a memory area SNC; whereupon the amount from the memory area SNC is divided by the amount of the total braking power SWG, and the result is stored in the memory SW (Step 308), and the result of the wear monitoring is sent to an info system in a step 309, in which info system, in the event of conspicuousness, a corresponding output takes place, for example, by way of a video screen of the vehicle.

FIG. 4, and on, show additional advantageous functions which can be implemented by means of the release play adjustment according to the invention.

Thus, possibilities are obtained for

1. determining the application point in time of the brake;

2. for monitoring the wear;

3. for cleaning (cleaning function, wetness, de-icing salt, dirt);

4. for the individual release play adjustment on both sides of the brake disc;

5. for the active restoring of the brake disc after a braking operation;

6. for securing the displaceability of the brake disc by sliding the brake disc back and forth over its entire displacement range during an unbraked drive in order to keep the displacement path free of dirt, corrosion, etc. and examine the displaceability of the brake;

7. for sensing the brake pad wear.

A cleaning function can be implemented in that, by means of the electric wear adjusting system, the brake pads are, periodically or under defined conditions, during an unbraked drive, brought continuously into a slightly grinding contact with the brake disc.

Advantageously, the contacting and cleaning operation is not carried out simultaneously at the friction surfaces of the brake disc because the occurring heating results in a thermal expansion of the brake disc and the brake pads and thereby may cause a deformation of the brake possibly with the result of an overheating.

This applies particularly when a braking is initiated during the cleaning operation. The cleaning operation is essentially carried out such that the adjusting device is moved on one side of the brake disc in the sense of a release play reduction in the direction of the brake disc which it cleans in a slightly grinding manner, while simultaneously the opposite adjusting device is controlled such that it moves away from the brake disc. Subsequently, this operation can be reversed and/or can be repeated as a function of the requirement or automatically.

FIG. 4 shows a routine for ensuring the displaceability of the brake and for implementing a cleaning function.

After the start of the routine, it is first checked whether a brake release signal was sent by the CAN bus (Step 401).

If this is so, the waiting time since the last cleaning operation is compared with a limit value TW in a next step 402.

If the waiting time was exceeded, the rotational wheel speed is determined in a Step 403 and is stored in a memory area SNC.

If the value in the memory area SNC is lower than a limit value in NCmin, a controlling of the electric motor takes place on the outside for rotating the adjusting screws in the direction of an enlargement of the release play (Step 404) as well as subsequently a controlling of the interior electric motor for the rotation of the adjusting screws in the direction of a reduction of the release play (Step 405).

If now the decoding pulses at the motor on the outside and at the motor on the inside reach a defined value K (Step 406), a further controlling of the electric motor takes place on the outside for rotating the adjusting screws in the direction of a reduction of the release play (407) as well as another controlling of the electric motor 7 takes place for rotating the adjusting screws in the direction of an enlargement of the release play (Step 408).

If here also the defined number of K decoding pulses was reached (Step 409), it is checked whether furthermore an off-road key is switched; that is, whether, in addition, the cleaning function was activated by the driver (Step 410). If this is not so, the routine is stopped; otherwise, the program returns to Step 402 or 403; that is, for example, for checking the waiting time.

Correspondingly, by means of the brakes, an advantageous adjustment of the braking system can be implemented under the effects of wetness and de-icing salt. Thus, in this case, a periodic contacting of the brake pads takes place at defined time intervals in order to protect the brake disc from the effects of wetness and de-icing salt. This measure has the purpose of preventing a decrease of the effect of the brakes because of a reduction of the coefficient of friction.

Under the effect of dirt, particularly in the off-road and construction site operation, the cleaning function is triggered by the driver by operating a switch or automatically at driving speeds below a certain limit value, for example, 10 km/h, or activated by a combination of the two measures (triggered by the driver), but only below, for example, 10 km/h. At low driving speeds and a high dirt-caused strain, —for example, when driving in sand—the brake is to be operated in a constantly slightly grinding manner. This function is used for keeping the friction surfaces of the brake pads and the brake disc free of wear-increasing abrasive dirt.

By means of the invention, it is also possible to carry out an individual release play adjustment. For this purpose, the release play is adjusted to be unequal on the two sides of the brake disc when an unequally high brake pad wear occurs. Such a control method is illustrated in FIG. 5.

After the start of the routine, it is first determined in Step 501 whether a brake operating signal was sent by the CAN bus. If this is so, it is determined whether a command for the adjustment is present in the CAN bus (for example, when a braking power limit value was exceeded—Step 502).

If this is so, the electric motors are controlled on the outside and the inside in order to reduce the release play (Step 503).

As soon as the electric motors stop on the outside and the inside, the brake pads have contact (Step 504).

In this case, a stop message is sent to the EBS system (Step 505) and the electric motors are switched currentless (506).

As soon as a brake release signal was sent by the CAN bus (Step 507), the electric motor are controlled on the outside and the inside for rotating the adjusting screws in the direction of a reduction of the release play (Step 508).

When the two electric motors (Step 509) are stopped, the amount of the wear decoding of the interior pad is read out of the wear value memory SNI (510), and then the amount of the wear value memory SNI is multiplied by an adjuster constant C and is stored in a memory area SNCI (Step 511).

Then the amount of the wear decoding of the pad on the outside is read out of the wear value memory SNA (Step 512), and the amount of the wear value memory SNA is multiplied with an adjuster constant C (Step 513) and is stored in a memory field SNCA.

Then, in another Step 514 (see FIG. 5b), the values SNCI and SNCA are compared with one another by subtracting the value SNCA from SNCI.

Depending on whether or not the amount of SNCA minus SNCI is higher than a defined value D, either in a Step 516, a controlling at the electric motors on the outside and inside is caused by x decoding pulses in order to increase the release play.

As soon as the x decoding pulses have been reached (Step 517), the amount of the added-up decoding pulses is reported to the EBS wear value memory (areas SNA and SNI) (Step 518).

If, in contrast, SNCA minus SNCI is higher than the given value d, an unequal condition exists at the inner and outer brake pad which deviates more than defined from a limit condition.

Depending on whether SNCA minus SNCI is larger or smaller than zero (Step 516), a different controlling of the electric motors takes place on the outside and the inside. Thus, in Step 517, either the outer electric motor is controlled by x plus b decoding pulses in the release play enlargement direction or is controlled by x minus b decoding pulses in the release play enlarging direction (Step 517, 517′) and the electric motor is correspondingly controlled on the inside either by x minus b or by x plus b decoding pulses in the direction of an enlargement of the release play (Step 518, 518′). After the defined number of decoding pulses has been reached (Steps 519, 519′, 520, 520′), the amount of the added-up decoding pulses is reported to the EBS wear value memories SNA and SNI (Steps 521, 521′) and the routine is stopped.

For the active restoring of the brake disc after a braking operation, the brake disc is moved back into its initial position, if the latter is designed to be slidable in order to again implement the full working stroke during the next braking operation. For this purpose, for example, a stop may advantageously be provided on the receiving profile of the wheel hub toward the interior side of the vehicle or toward the side of the brake on which the brake lever to be operated is arranged. After the release of the brake, the brake disc is displaced by the adjusting device situated on the outside by a defined amount in the direction against this stop, in which case, the adjusting device situated on the interior moves back correspondingly.

A corresponding function is shown by FIG. 6.

After the start of the routine for the active restoring of the brake disc, it is checked in a Step 601 whether a brake release signal is present in the CAN bus. Then the outer motor is controlled in a Step 602 in order to control the adjusting screw by f decoding pulses in the direction of the reduction of the release play. Then, or while this is taking place, the inner electric motor is controlled and the adjusting screws are to be controlled by f decoding pulses in the direction of a release play enlargement. As soon as the limit value f is present (Step 604), the outer electric motor A is controlled for the rotation of the adjusting screws in the direction of the release play enlargement by f decoding pulses (Step 605), and the inner electric motor for rotating the adjusting screws in the direction of a release play reduction is also controlled by f decoding pulses (Step 606). As soon as the limit value f has been reached (Step 607), the routine is stopped.

By means of the invention, it is also possible to monitor the displaceability of the brake disc. For monitoring the free mobility of the brake disc in its hub accommodation profile as well as for ensuring the free mobility, the brake disc is moved back and forth along its entire sliding path at periodic intervals while the vehicle wheel is rotating. This displacing can take place once or several times successively. For this purpose, the adjusting devices situated on the inside and outside are correspondingly controlled in opposite directions. By means of the frequent displacement while the vehicle wheel is rotating, the accommodation profile is kept free of dirt and corrosion. Simultaneously, by way of a possibly changed electric power consumption of the adjusting motors, a starting sluggishness can be recognized in time and a warning indication can be generated by the electronic adjuster control system. As required, it may be advantageous to use this testing routine in connection with the cleaning function (see FIG. 4 for this purpose).

For sensing the total brake pad wear, an analyzing of the decoder signals of the electric drives of the adjusting system can take place. By adding up the decoder pulses, the rotating angle of the adjusting screws is detected and used in a wear information for the purpose of a wear indication or for the purpose of the wear compensation control with respect to the axles.

Per revolution of the motor, the decoding device of the EC motors emits a constant number of voltage pulses, but at least one pulse per revolution. While including the transmission ratio of the transmission connected on the output side and the thread pitch in the adjusting screws, one adjusting path of the adjusting screws can be assigned to each added-up voltage pulse.

The decoding device acts as a rotational angle sensor of the adjusting screws, and the wear detection takes place according to a variant analogous to the method practiced in the case of Knorr SB/SN brakes. Instead of the decoding device of the EC motor, a corresponding device can also be arranged on one of the gearwheels of the transmission connected on the output side, which consists, for example, of two Hall sensors and a magnetic coding on the assigned gearwheel. In every case, the decoding device is constructed such that a differentiation is made between the right-handed rotation and the left-handed rotation of the EC motor; that is, between the forward and backward motion of the adjusting screws. The counting pulses during the forward motion are added up with positive signs, and the counting pulses during the backward motion are added up with negative signs. In this manner the information concerning the occurred wear is formed by the electronic analyzing system and is transmitted to the electronic control system and/or the driver information system or the service information system.

In the case if a decoding device which transmits, for example, three voltage pulses per motor revolution, a total transmission ratio of the transmission connected on the output side of, for example, 700:1, and a thread pitch of, for example, 2 mm, the following resolution of the wear detection is obtained:

C=(S/i_{ges})t

C=adjusting path per decoding pulse

S=pitch of the thread of the adjusting screws

i_{ges}=total transmission ratio of the transmission

t=number of decoding pulses per revolution

With S=2 mm; i_{ges}=700; t=3, the following is obtained:
C=2 mm/700×3
C=0.000952 mm.

### LIST OF REFERENCE NUMBERS

Caliper 1
brake disc 3
brake pad 5
brake pad support 5a/5b
brake pad 7
brake pad support 7a/7b
section 9
bolt 11
axle flange 13
adjusting device 15
adjusting device 17
adjusting sleeve 19
adjusting sleeve 19
adjusting sleeve 21
pressure piece 23
pressure piece 23
projection 24
pressure piece 25
pressure piece 25
rotary lever 27
piston rod 29
gearwheel/projection 33
gearwheel 35
gearwheel 37
gearwheel 39
electric motor 41
data and supply line 43
control device 45

1. Control method for controlling an adjusting system of a disc brake, having a caliper which reaches over a brake disc, brake pads arranged on both sides of the brake disc, an application device for applying the disc brake and the adjusting system, which can be controlled by way of a control device and is designed with an electric motor, for adjusting the brake pads in the event of the occurrence of a brake pad wear, the control method being implemented by means of a program of the control device and having the steps of
determining the braking power occurring during a braking,
comparing the determined braking power with a braking power limit value,
controlling the adjusting system for implementing an adjustment in the event of an exceeding of the braking power limit value.

2. Control method according to claim 1, wherein the amount of the braking power converted during a braking is intermediately stored in a memory, is added up over several brakings and is then compared with the prestored braking power limit value.

3. Control method according to claim 1, wherein the braking power is computed from the braking torque and the rotational wheel angle.

4. Control method according to claim 3, wherein the rotational wheel angle is determined by means of an ABS system having a revolving field sensor.

5. Control method according to claim 3, wherein the braking torque is determined from the brake cylinder pressure.

6. Control method according to claim 1, wherein the braking power is computed according to the formula
MB=(P_{Z}−P_{An})A_{Z}iC*r_{eff},
wherein
P_{Z}=pressure in the brake cylinder and application pressure of the brake
P_{An}=application pressure of the brake
i=power ratio of the brake [symbol]
=mechanical efficiency of the power ratio mechanism of the brake
C*=brake coefficient˜2X˜B
μ_{B}=coefficient of friction of the brake pad
r_{eff}=effective friction radius of the brake disc
Z=number of added-up rotational angle pulses of an ABS revolving field
A_{Z}=effective piston surface of the brake cylinder.

7. Control method according to claim 1, wherein the braking power converted for each rotation corresponding to a tooth of an ABS revolving field, thus per rotational speed pulse, is determined by
w=(P_{Z}−P_{An})K
wherein
K=A_{Z}i [symbol] C*r_{eff} 2 [symbol] /n
P_{Z}=pressure in the brake cylinder and
P_{An}=application pressure of the brake.

8. Control method according to claim 1, wherein an adjustment is initiated when a power limit value of 2 to 8 MJ is exceeded.

9. Control method according to claim 1, wherein an adjustment is initiated when a power limit value of 5 MJ is exceeded.

10. Control method according to claim 1, wherein the amounts of the converted braking power added up since the start of the operation of the vehicle or since the brake pad change are detected and added up and are compared with defined values in order to determine and indicate and/or correct conditions which lead to an excessive brake wear.

11. Control method according to claim 1, wherein, after a termination of the braking operation, the adjusting device is controlled in the sense of a reduction of the release play until, when the brake pads rest in a zero play against the brake disc, the motor is stopped by the friction force occurring in the adjusting screws, whereupon, from the zero play position, a controlling takes place in the release direction, a defined number of motor revolutions being implemented in order to generate the desired release play.

12. Control method according to claim 1, wherein, for cleaning the brake disc, by means of the electric wear adjusting system, the brake pads are, periodically and/or under defined conditions, during an unbraked drive, also brought continuously into a slightly grinding contact (with? translator) the brake disc.

13. Control method according to claim 12, wherein the brake pads are brought in contact with brake disc successively at the two mutually opposite brake pads of the disc brake.

14. Control method according to claim 12, wherein the cleaning of the brake disc is implemented after each start of the vehicle and is repeated during the drive at defined intervals.

15. Control method according to claim 12, wherein the cleaning of the brake disc takes place when a wetness and/or winter operating signal is present.

16. Control method according to claim 12, wherein the cleaning function is triggered by a manual triggering by the driver, preferably by operating a switch, or by a falling below a vehicle speed limit value.

17. Control method according to claim 16, wherein the limit value is at less than 15 km/h, preferably at 10 km/h or less.

18. Control method according to claim 1, wherein for monitoring and ensuring the displaceability of the brake disc, the brake disc is slid back and forth along its entire or partial sliding path by means of the wear adjusting system, while the vehicle wheel is rotating.

19. Control method according to claim 18, wherein the displacing of the brake disc takes place periodically.

20. Control method according to claim 1, wherein the total brake pad wear is determined by adding up the wear adjusting movements of the electric wear adjusting system.

21. Control method according to claim 1, wherein the application point in time of the brake is determined in that, after one or more brakings, the adjusting system is controlled in the sense of an adjustment until the at least one adjusting motor is stopped by the friction occurring as a result of the application force.

22. Control method according to claim 21, wherein the application point in time of the adjusting motor is determined by means of a monitoring of the voltage and/or current characteristic of the adjusting motor when applied to the brake disc.

23. Control method according to claim 21, wherein the application point in time on both sides of the brake disc is separately determined in that the moment is determined by which the at least one adjusting motor on each side of the brake disc is stopped by the friction occurring as a result of the application force.

24. Control method according to claim 23, wherein when determining an unequally high brake pad wear on both sides of the brake, on the basis of a determination of unequal application points in time, the release play on both sides of the brake disc is adjusted to be unequal.

25. Control method for controlling all brakes of a vehicle or of a vehicle combination, wherein by means of the determination of the application point in time of each brake by means of a control method of claim 21 and a comparison of the application point in time of different brakes of the vehicle or of a vehicle combination—consisting of a traction vehicle and a trailer vehicle—, the different brakes of the vehicle are adjusted such that the application points in time of the various brakes are mutually adapted.

26. Control method according to claim 25, wherein the braking power is computed from the braking torque and the rotational wheel angle covered when braking.

27. Control method according to claim 26 in which the amounts of converted braking power added up since the start of the operation of the vehicle or since the last brake pad change are detected and added up and/or indicated to a driver by means of indicating device.
